(19) United States
(12) Patent Application Publication
(10) Pub. No.: US 2022/0396166 A1
(43) Pub. Date: Dec. 15, 2022

(54) POSITIONING DEVICE FOR INDUCTIVE CHARGING OF LIGHT ELECTRIC MOBILITY DEVICE

(71) Applicant: MOBY HEALTH S.R.L., Napoli (IT)

(72) Inventor: Antonio CUCCO, Acerra (NA) (IT)

(21) Appl. No.: 17/775,284

(22) PCT Filed: Nov. 8, 2019
(86) PCT No.: PCT/IT2019/000092

§ 371 Date: May 7, 2022

(51) Int. Cl. B60L 53/38

(52) U.S. Cl. CPC B60L 53/38; B60L 2200/24

(57) ABSTRACT

The field of the art to which the present invention refers is that of mechanical devices which can be universally fixed on the side of electric wheelchairs, on mobility scooters or in general on other electric mobility devices on wheels, for the precision parking of the devices and for their inductive electric charge. The invention is so that, when the part a, integral with the electrical device, is inserted in the part β, integral with a fixed point perpendicular to the floor (wall, pole, etc. . . . ), the receiving wireless plate (installed on part a) is in a position of precise alignment to the transmitting wireless plate (installed on part β) and the correct technical distance required for the activation of the inductive charging process and/or for the additional bidirectional communication of parameters and operating data. The invention can be mounted on any light electric mobility devices with wheels and to every vertical surface.

### FIELD OF THE ART TO WHICH THE INVENTION REFERS

The field of the art to which the present invention refers is that of mechanical devices which can be universally fixed on the side of electric wheelchairs, on mobility scooters or in general on other electric mobility devices on wheels (all the aforementioned mobility devices, hereinafter referred to simply as “scooters”) for the precision parking of the scooters and for their inductive electric charge.

### STATE OF THE PRE-EXISTING TECHNIQUE CONCERNING THE FIELD OF REFERENCE OF THE INVENTION

At the date there are no universal mechanical devices that can be fixed laterally on wheelchairs, on mobility scooters or on other electric mobility devices on wheels (the “scooters”), aimed at their precision parking and their inductive charging.

### INVENTION DETAILS AND ADVANTAGES INTRODUCED WITH RESPECT TO THE PRE-EXISTING TECHNIQUE

The invention consists of n. 2 main units:
a part α, integral with the electric device, consisting of a BT micro-adjustable telescopic arm, complete with SD support for its attachment to a square or cylindrical element on the side of the electrical device, connected to a reclining arm BR through a hinge complete with a return mechanism MR, complete with a shaped support bracket for the RV wireless receiving plate and a GD guide provided with a hole IN;
a part β, integral with a fixed point perpendicular to the floor (wall, pole, etc.) consisting of a track BN, a blocking element EB (manual or electrically controlled) an FC end-of-stroke element, a shaped support bracket for the wireless transmitting plate TR.

The device is such that, fixed SD to the electrical device, the micro-adjustment of the BT arm is carried to set the GD guide and consequently of the RV wireless receiving plate beyond any lateral protrusion characterizing the device (handlebar, armrest, etc.).

The BR arm in its rest position will remain parallel to the side of the device.

Extending the BR arm outwards it is possible to insert the GD guide in the BN track. The guide GD will slide inside the track BN until it reaches the end-of-travel element FC, the locking element EB automatically engages in the hole IN of said guide, locking it mechanically and thus fixing the plate RV in a position of precise alignment with the TR plate and the correct technical distance required for the activation of the TR/RV inductive charging process and/or for the additional bidirectional TR/RV communication of parameters and operating data.

The blocking element EB keeps the electrical device in the same position of precision and technical distance useful for the wireless transmission TR/RV and/or the additional bidirectional communication, during the entire duration of the parking.

If electro-controlled, with consent to release through remote control systems (ex. remote control) and/or control radio frequency (ex. RFID) and/or data (bluetooth, 3G, 4G and 5G), the locking element EB can also withstand unauthorized actions to disengage the GD guide from the BN track.

When the GD guide will run in the opposite direction, after passing the blocking element EB, after exiting the track BN the arm BR will automatically return to its rest position.

The advantages of the present invention, respect to the stationary and recharging systems currently on the market, are represented by the universality and standardization of the device.

The α part of the invention can be in fact implemented on every type of electric wheelchair, mobility scooter or more generally on every type of light electric mobility device on wheels, thanks:
to a support SD which allows the coupling to elements of the scooters, of square shape and cylindrical shape;
to a micro-adjustable telescopic arm BT that allows the GD guide and consequently the RV wireless receiver plate to be moved away from the side of the electrical device, beyond any lateral protrusion (handlebar, armrest, etc.).

The β part of the invention can also be applied to each vertical element. The BN track, thanks to its small dimensions, can in fact be easily fixed to any vertical artifact (wall, pole etc.) or even recessed in it.

Finally, both the α part and the β part of the invention have a flat support for the universal application of the receiving/transmitting plates.

The invention composed of the parts α and β is therefore a universal kit that will allow:
to the owners of a wheelchair, a mobility scooter, etc . . . , to park them parallel to a wall of the house, the garage, etc . . . , with activation of their inductive charging in an orderly and technically correct manner;
to hospitals, residences for the elderly, etc . . . , to manage in a professional manner the parking and simultaneous recharging of electric wheelchairs with an effective technical solution that does not take away space from the lanes and corridors;
to hotels, the technically correct inductive charging, even in the room, of their fleet of electric wheelchairs, mobility scooters, etc . . . , to be given to their guests.

### DESCRIPTION OF THE DRAWINGS

FIG. 1 shows the invention in question, with an indication of the abbreviations used previously.

FIG. 2 shows the part α of the subject invention in its rest position.

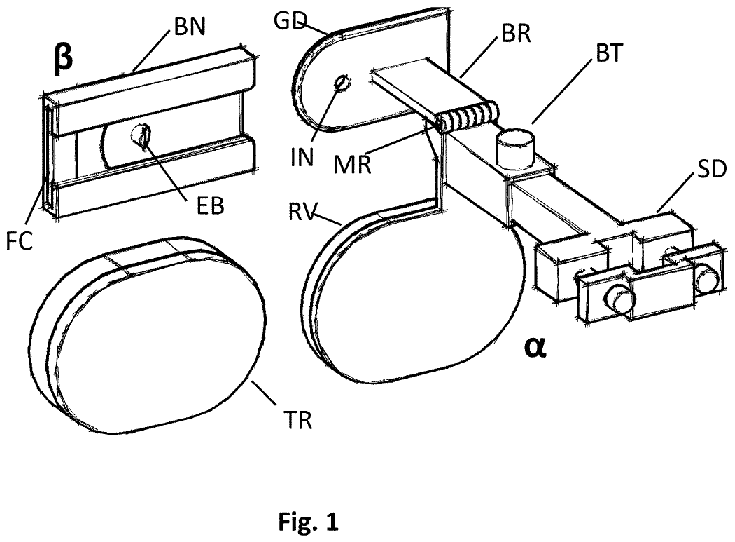

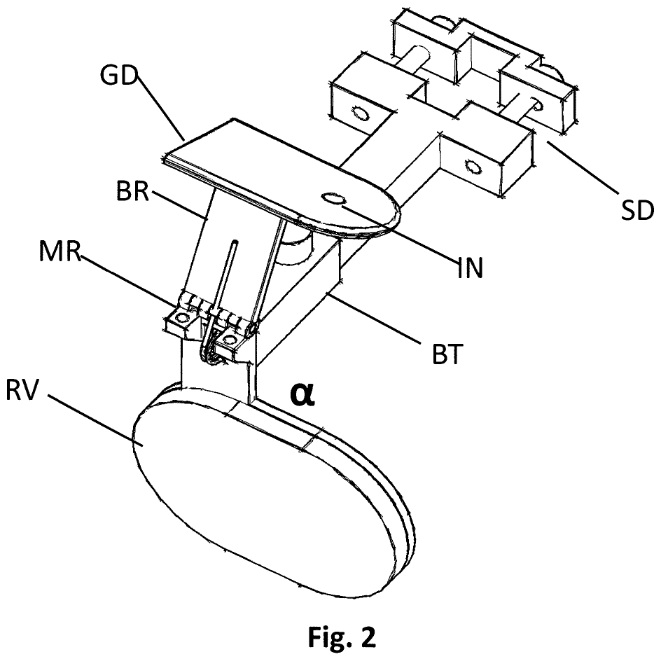

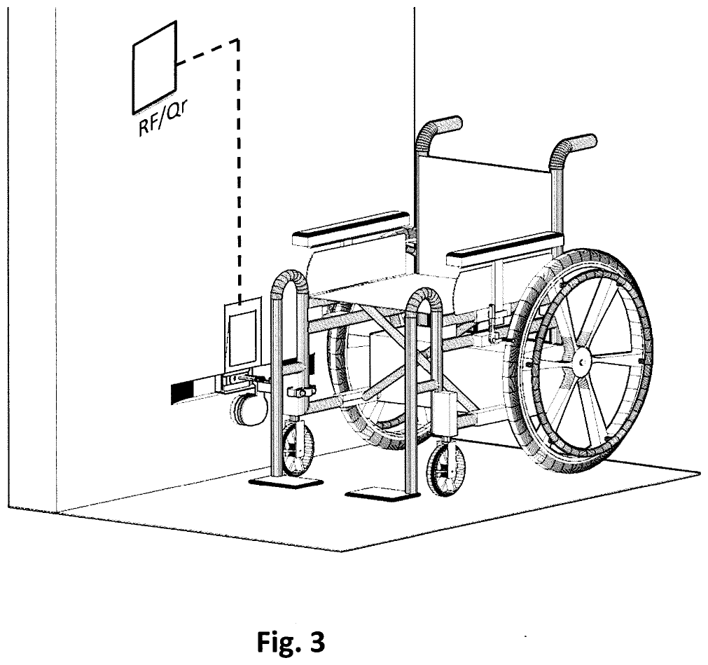

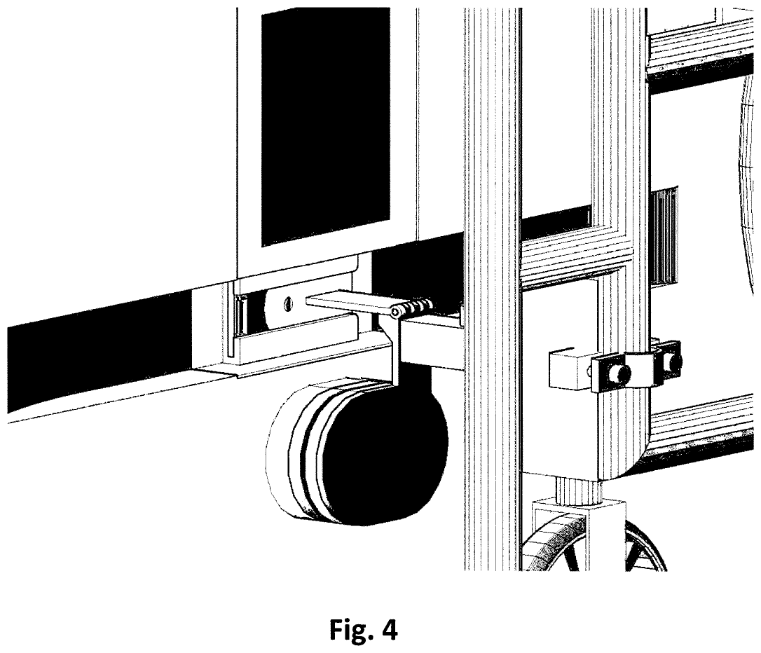

### DESCRIPTION OF AN APPLICATION OF THE INVENTION

FIG. 3 shows an implementation of the invention in question. In this case the α part of the invention was implemented on an electric wheelchair, the β part on a vertical wall. Thanks to the use, as a blocking element EB, of an electronically operable servomechanism and its interfacing with a user recognition system, such as an RFID (RF) or qrcode (QR) card reader, the wheelchair release occurs only to authorized users such as nurses in a hospital.

FIG. 4 shows a detail of the described implementation, with evidence of the recessing of the β part of the invention in a vertical wall

1. Mechanical device for lateral fixing to light electric mobility devices of wheeled type able to allow precision parking of a light electric mobility device, with automatic alignment to a correct distance of a receiving plate (RV) and transmitting plate (TR) for the inductive charging of the light electric mobility devices, whereby said device further comprising
a first part (a) integral with the light electric mobility device, consisting of a micro-adjustable telescopic arm (BT), complete with support (SD) for attachment to a square or cylindrical element disposed on a side of the light electric mobility device, connected to a reclining arm (BR) through a hinge having a return mechanism (MR) having a shaped support bracket for the wireless receiving plate (RV) and a guide (GD) provided with a hole (IN), and,
a second part (β), integral with a fixed point perpendicular to the floor and consisting of a track (BN), a blocking element (EB) an end-of-stroke element (FC), and a shaped support bracket for the wireless transmitting plate (TR), and,
wherein, at rest position, first part (α) and second part (β) are disjoint, and reclining arm (BR) is parallel to side of the light electric mobility device, wherein when extending arm (BR) outwards, the light electric mobility device allows insert of guide (GD) in track (BN), and blocking element (EB) automatically engages hole (IN) of guide (GD), the receiving plate (RV) is in a position of precise alignment with the transmitting plate (TR) and with the correct technical distance required for activation of the inductive charging process.

2. (canceled)

3. (canceled)

4. (canceled)

5. Device according to claim 1, wherein when the receiving plate (RV) is in a position of precise alignment with the transmitting plate (TR) and with the correct technical distance required for activation of the inductive charging process, the bidirectional communication is additionally started, during the whole duration of the parking.

6. Device according to claim 1, wherein the locking element (EB) is remotely controlled by radio frequency command and/or by data connection command of the BLUETOOTH, 3G, 4G or 5G type.

7. Device according to claim 1, wherein blocking element resists unauthorized actions to disengage the guide (GD) from the track (BN).
